(19) United States
(12) Patent Application Publication
(10) Pub. No.: US 2015/0339111 A1
(43) Pub. Date: Nov. 26, 2015

(54) AUTOMATIC DISCOVERY AND INSTALLATION OF APPLICATIONS VIA THE INTERNET IN RESPONSE TO COUPLING OF HARDWARE DEVICE TO COMPUTING DEVICE

(71) Applicant: GOOGLE INC., Mountain View, CA (US)

(72) Inventor: Pranav Kumar Kedia, Sammamish, WA (US)

(73) Assignee: GOOGLE INC., Mountain View, CA (US)

(21) Appl. No.: 14/283,640

(22) Filed: May 21, 2014

(51) Int. Cl. G06F 9/445

(52) U.S. Cl. CPC G06F 8/61

(57) ABSTRACT

A computer-implemented method includes receiving a first indication that a hardware device has been coupled to a computing device and receiving a second indication that the computing device does not have installed a device-specific application that provides dedicated communication services between the hardware device and an operating system of the computing device. In response to receiving the first and second indications, a database of applications for device-specific applications that provide dedicated communication services between the hardware device and an operating system of the computing device is automatically queried. One or more applications from the database that satisfy the query are displayed to a user.

### TECHNICAL FIELD

This document relates generally to applications used with computing devices and, in particular, to the automatic discovery of applications via the Internet in response to the coupling of a hardware device to a computing device.

### BACKGROUND

As more and more hardware devices are being connected with computing devices, a challenge exists to provide resources to facilitate communication between the hardware devices and the computing devices. Traditionally, hardware devices have been sold or shipped with accompanying software (e.g., a device driver) that would be installed on the users computing device to provide a device-specific application that provides dedicated communication services between the hardware device and an operating system of the computing device. The software could be stored on a computer-readable medium, e.g., a floppy disk or a CD, and installed on the computing device after the medium is inserted into a computer-readable medium reader (e.g., a floppy disk drive or a CD drive) and read by the computing device. However, as computing devices become smaller, they may no longer have drives to read floppy disks or CDs and/or developers and vendors may not wish to ship their devices with a computer-readable medium that stores such software.

Thus, a need exists to address the aforementioned problems with the existing art.

### SUMMARY

In a first general aspect, a computer-implemented method includes receiving a first indication that a hardware device has been coupled to a computing device and receiving a second indication that the computing device does not have installed a device-specific application that provides dedicated communication services between the hardware device and an operating system of the computing device. In response to receiving the first and second indications, a database of applications for device-specific applications that provide dedicated communication services between the hardware device and an operating system of the computing device is automatically queried. One or more applications from the database that satisfy the query are displayed to a user.

Implementations can include one or more of the following features. For example, a selection of one of the one or more displayed applications can be received, and the selected one of the displayed applications can be installed. Installing the selected one of the displayed applications can include launching the application on the computing device and initiating communication between the device and the operating system through the launched application. Receiving the first indication that a hardware device has been coupled to a computing device can include receiving information about a vendor of the device, and the query can be based, at least in part, on the information about the vendor. Receiving the first indication that a hardware device has been coupled to a computing device can include receiving a product ID of the device and the query can be based, at least in part, on the product ID.

The device can be coupled to the computing device via a USB link, and receiving the first indication that a hardware device has been coupled to a computing device can include receiving a device descriptor that identifies the device, and the query is based, at least in part, on the information about the device descriptor. The device can be coupled to the computing device via a Bluetooth link, and receiving the first indication that a hardware device has been coupled to a computing device can include receiving a UUID that identifies the device, and the query can be based, at least in part, on the information about the UUID. The database can maintain an index of metadata information about the applications in the database, and querying the database can include querying the index with one or more search terms descriptive of the device, which are matched against the index. Terms of the index can be based on terms found in manifests of applications in the database.

In another general aspect, a computer-implemented method includes receiving device-specific applications for inclusion in a database of applications, where the device-specific applications provide dedicated communication services between a hardware device connected to a computing device and an operating system of the computing device. The applications are indexed in an index of applications that are available in the database. A query is received from a computing device connected to the database via the Internet for one or more device-specific applications that provide dedicated communication services between a hardware device connected to the computing device and an operating system of the computing device, where the query is automatically sent from the computing device to the database in response to the hardware device being connected to the computing device. The query is executed against the index, and, responsive to the query, indications of one or more applications that satisfy the query are provided to a user of the computing device.

Implementations can include one or more of the following features. For example, providing indications of the one or more applications that satisfy the query can include proving indications only of applications that satisfy the query and that have been validated as being associated with an approved developer for the hardware device. Indexing the applications can include indexing the applications based on information contained in manifests of the applications. Information in a manifest for an application that provides dedicated communication services between a hardware device connected to a computing device via a Bluetooth link and an operating system of the computing device can include a UUID for the hardware device. Information in a manifest for an application that provides dedicated communication services between a hardware device connected to a computing device via a USB link and an operating system of the computing device can include a device descriptor ID for the hardware device.

A selection of one of the applications that satisfies the query can be received, and in response to receiving the selection, the selected application can be provided to the computing device. The device can be coupled to the computing device via a USB link, and the query can be based, at least in part, on the information about a device descriptor that identifies the device. The device can be coupled to the computing device via a Bluetooth link, and the query can be based, at least in part, on the information about a UUID that identifies the device.

In another general aspect, computer-implemented method includes receiving an indication that a hardware device has been coupled to a computing device. In response to receiving the indication, a database of applications is automatically queried for user-level applications that are intended for use with the hardware device when the hardware device is coupled to a computing device, and one or more applications from the database that satisfy the query are displayed to a user.

Implementations can include one or more of the following features. For example, a selection of one of the one or more displayed applications can be received, and the selected one of the displayed applications can be displayed. The device can be coupled to the computing device via a USB link, and receiving the indication that a hardware device has been coupled to a computing device can include receiving a device descriptor that identifies the device, and the query can be based, at least in part, on the information about the device descriptor.

### BRIEF DESCRIPTION OF THE DRAWINGS

FIG. 1 is a block diagram of a system in which a hardware device is coupled to a computing device.

FIG. 2 is a screenshot of a user interface to a marketplace of digital goods.

FIG. 3 is a schematic block diagram of an example embodiment of a system used to search for and identify digital goods in a marketplace.

FIG. 4 is a screenshot of the user interface to a marketplace of digital goods.

FIG. 5 is a flowchart of a process for automatically identifying device-specific applications that provide dedicated communication services between a hardware device and a computing device.

FIG. 6 is a flowchart of a process for automatically identifying device-specific applications that provide dedicated communication services between a hardware device and a computing device.

FIG. 7 is a flowchart of a process for automatically identifying user-level applications that are intended to be used with a particular hardware device when the hardware device is coupled to a computing device.

FIG. 8 shows an example of a computer device and a mobile computer device, which may be used with the techniques described here.

Like reference symbols in the various drawings indicate like elements.

### DETAILED DESCRIPTION

This document describes systems and techniques for automatically searching for and identifying device-specific applications (e.g., device drivers) that provide dedicated communication services between hardware devices and operating systems of computing devices. The automatic search can be initiated in response to a hardware device being linked to a computing device, for example, when a hardware device is coupled to a computing device via a Bluetooth or a USB link. The automatic search can be executed over a curated data store 132 that hosts applications, including device-specific applications, which have been approved for installation and use on a computing device. Thus, when a hardware device is coupled to a computing device, even if a device driver for the specific hardware device is not installed on the computing device, a search for an appropriate device driver can be automatically initiated in response to the coupling of the hardware device to the computing device. The results of the search can be presented to a user of the computing device, and the user can elect to install a device driver for the hardware device on the computing device.

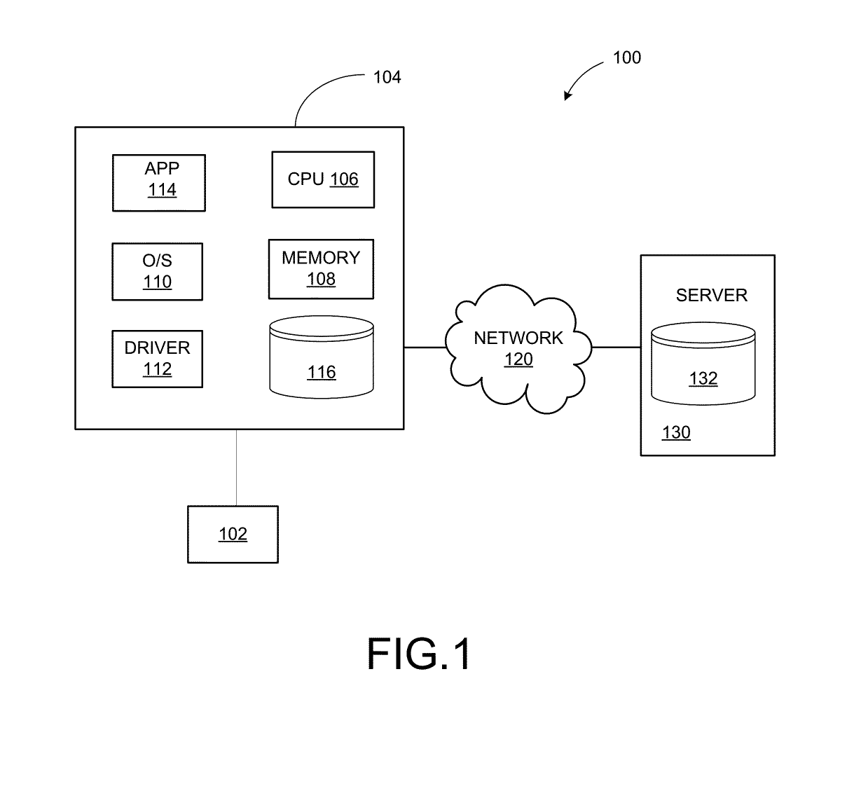

FIG. 1 is a block diagram of a system 100 in which a hardware device 102 is coupled to a computing device 104. The hardware device 102 can be used to perform a specialized function for a user, alone or in combination with the computing device to which it is coupled. Some non-limiting examples of the hardware device include: a standalone GPS device that determines a position through communication with orbiting satellites and which communicates positional data to the computing device 104 and where the GPS device receives updated map information from a connected computing device; a smart-watch that performs certain functions while coupled to a computing device, such as, for example, a smart phone, a tablet, or a phablet; a wearable computing device, such as, for example, eyeglasses equipped with a camera, a head-up display, memory, and a processor, which is coupled to the computing device 104; a monitor that detects physiological data (e.g., heart rate, movement, temperature, sleep state, etc.) of a user and that communicates the detected data to a coupled computing device. The computing device 104 can include a processor (e.g., a central processing unit) 106 and memory resources (e.g., volatile memory 108 and non-volatile memory 116). The computing device 104 can include an operating system 110 and a kernel-level application 112 specific to the hardware device that provides dedicated communication services between the hardware device 102 and the operating system 110 of the computing device 104. The computing device 104 can include a user-level application 114 that provides a user interface to functions of the hardware device 102 and access to, manipulation of, and analysis of, data obtained from the hardware device 102. Commands can be issued to the hardware device from the application 114 and from the operating system 110 through the kernel-level device driver 112, and data from the hardware device can be communicated to the operating system 110 and the application 114 through the device driver 112.

The computing device 104 is connected to a server system 130 that is remotely located from the computing device 104 and that provides a data store 132 of many different applications that provide dedicated communication services between hardware devices and operating systems. The computing device 104 is connected to the server system 130 through a network (e.g., the Internet) 120.

When the hardware device 102 is connected to the computing device 104, a signal can be sent from the device to the computing device to indicate that a connection between the two devices has been made. For example, in some implementations, when the hardware device 102 is connected to the computing device 104, a hardware interrupt can be sent from the hardware device 102 to the operating system 110 of the computing device 104 to indicate that the hardware device 102 has been coupled to the computing device 104.

The hardware device 102 can be coupled to the computing device 104 over a wired or a wireless connection that uses a wired or wireless communication protocol, respectively. In some implementations, the hardware device 102 can be coupled to the computing device 104 through a Bluetooth link over which signals are exchanged between the two devices. In another implementation, the hardware device 102 can be coupled to the computing device 104 through a USB link over which signals are exchanged between the two devices.

Upon coupling of the hardware device 102 to the computing device 104, information sent from the hardware device to the computing device can include information that identifies the hardware device to the computing device. In some implementations, this information can be sent in response to a query from the operating system 110. For example, when a hardware device 102 is coupled via a Bluetooth link to the computing device 104, the hardware device can communicate a universally unique identifier (“UUID”) that identifies the hardware device product to the computing device. In another implementation, when the hardware device 102 is coupled via a USB link to the computing device 104, the hardware device can communicate device descriptor data (e.g., an IDvendor datum and an IDproduct datum) that identify the hardware device product to the computing device.

When the computing device 104 receives information that identifies the hardware device, local memory resources 108, 116 of the computing device can be searched for an application (e.g., a device driver) that provides dedicated communication services between the hardware device 102 and the operating system 104 of the computing device 104. If such an application exists within the local memory resources, or as part of the operating system 110, the application can be used loaded into memory 108 and executed by the processor 106 can provide dedicated communication services between the hardware device and the operating system.

If an application is not located within the local resources of the computing device 104, then, in response to the indication that the hardware device 102 is coupled to the computing device 104, a search for an appropriate application within the remote data store 132 can be initiated automatically (i.e., without human input to start the search, but rather in direct response to the indication that the hardware device 102 has been coupled to the computing device 104). In some implementations, the search can be conducted by passing information that identifies the hardware device 102 to an application 114 (e.g., a browser application) that connects to the remote server system 130 and issues a query for one or more applications that can be used to provide dedicated communication services between the hardware device 102 and the operating system 110 of the computing device 104. The query is based on the identifying information of the hardware device to the remote server system 130. The query can be executed on the remote server to identify one or more applications that satisfy the query and that are located in the data store 132 of the server system 130. The server system 130 can provide a marketplace of various digital goods (e.g., web applications, browser extensions, device drivers, etc.) that can be used to extend the functions and capabilities of the computing device 104.

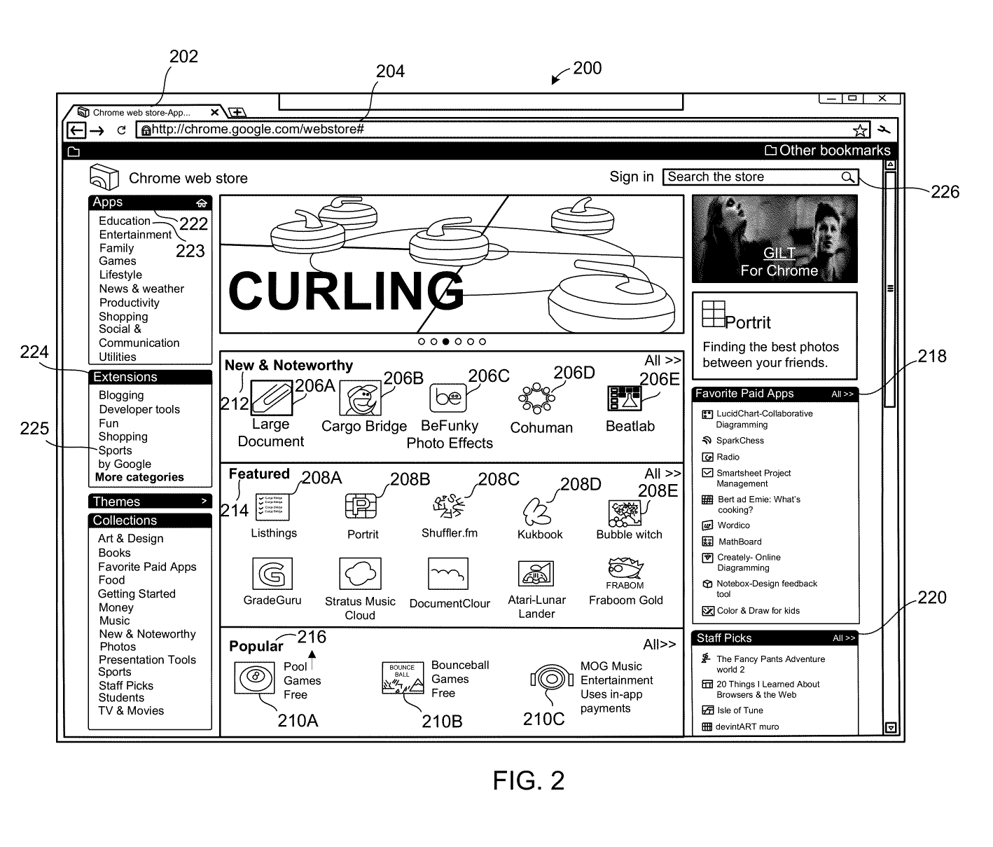

FIG. 2 is a screenshot of a user interface 200 to a marketplace of digital goods. The user interface 200 can be displayed by a browser application that is executed by the computing device 104 that is connected to the network (e.g., the Internet) 120. The browser application can open one or more tabs 202, one of which may display the user interface to the marketplace when a user navigates to a webpage identified by a uniform resource locator (URL) 204 that provides content to the browser so that the browser can display the user interface to the marketplace in the tab. In other implementations, a user interface to a marketplace of digital goods can be displayed in or by an application that does not depend on a browser for its display. For example, the user interface can be displayed in a widget that is executed by an operating system or a native application.

The content provided by the webpage to the user can include a plurality of icons 206A, 206B, 206C, 206D, 206E, 206F, 208A, 208B, 208C, 208D, 208E, 210A, 210B, 210C that represent digital goods that can be downloaded from the webpage by the user for execution by the computing device 104 controlled by the user. In some implementations, the digital goods can include any software or executable code (e.g., a desktop software program, a native application, a digital media file, such as a song or a movie, device drivers, etc.) In some implementations, the digital goods can include web applications that can be downloaded from the marketplace to a client computing device where they can be installed on the computing device for execution by a web browser running on the computing device. In this context, a “web application” may be configured to be executed or interpreted by the web browser. This is compared with native applications that include machine executable code and that are configured to be executed directly by a processor or via the operating system of the client device, whereas a web application may be incapable of execution or display without the aid of the web browser. Web applications may have their code bundled, so that the user can download all of the content of the web application for execution by the browser, such that the web application may not need to have network access to perform its functionality for the user, and rather may be executed successfully by the browser locally on the computing device without access to a network.

When installable web applications are “installed” by the user, the web applications may be added to and integrated with the user's web browser. An installation also allows web applications to obtain increased privileges without having to prompt the user for each one individually. “Installing” a web application may include integration with: a client's operating system's task and window managers for easy window switching, a taskbar or quick-launch system, interoperating system notification(s), or persistently running background processes. Uninstallation allows for easy removal or deactivation of an installed application from the user's browser or system, and may include revoking all associated privileges.

In some implementations, the device driver application can be implemented as a web application, or a browser extension, in that the device driver application can extend the functionality of the browser to provide a device-specific application that provides dedicated communication services between the hardware device and the operating system of the computing device. In other implementations, the device driver can be viewed as being independent of the browser application and as providing a device-specific application that provides dedicated communication services directly between the hardware device and an operating system of the computing device without the aid of a browser application.

In one example, a device driver application may be delivered to a computing device 104 for installation as an installation package that includes a zipped bundle of files (e.g., compressed, archive files) and a header that includes some metadata about the device driver application. When the device driver application is provided in the form of an extension, when unpacked and installed in the browser, the extension adds device driver functionality to the browser application. In some implementations, extensions may operate may have access to all of the application programming interfaces (APIs) that the browser application provides to webpages and/or web content.

The types of data files of a device driver application that can make up a zipped file bundle of an installation package may include hypertext mark-up language (HTML), cascading style sheets (CSS), JavaScript, images, and other types of files including web-related computer language content and/or code, such as JavaScript Object Notation (JSON) objects. JSON objects that may be part of an installation package include a manifest data file and a catalog data file. In an example implementation, a manifest file may be a JSON-formatted file that includes a plurality of information fields that are used to define the corresponding application. These fields may include a name field, a version field, as well as one or more fields that indicate any APIs the application wishes to have access to. The manifest of a device driver also may include information that identifies one or more hardware devices (e.g., by a Vendor ID and a Product ID or by a UUID) that the device driver application can be used with to provide dedicated communication services between the hardware device and an operating system of the computing device to which the hardware device is connected. This information then can be used to index the device driver applications in a marketplace of digital goods so that the device driver applications in the marketplace can be matched with their target hardware devices.

In an example implementation, a device driver for a particular hardware device may allow an application developer to extend the functionality of a USB API to communicate with a particular USB hardware device or may extend the functionality of a Bluetooth API to communicate with a particular Bluetooth-enabled hardware device. In such approaches, the manifest file for a given device driver application may indicate (declare) that it requires access to the USB/Bluetooth API in order to provide the device driver communication services between the hardware device 102 and the operating system 110 of the computing device 104.

Within the user interface 200, the digital goods can be displayed in a manner that is organized to help a user decide which applications may be useful or relevant to the user. For example, the user interface 200 can include a category 212 of applications 206A, 206B, 206C, 206D, 206E, 206F that have been recently released in the marketplace and which a curator of the marketplace may deem to be especially noteworthy to users. In one implementation, the applications 206A, 206B, 206C, 206D, 206E, 206F shown in the category 212 can be limited to applications that have been released in the marketplace within a recent period of time (e.g. one week, one month, three months, six months). Then, a subset of the applications that have been released into the marketplace within the recent period of time can be selected based on a variety of signals that indicate the noteworthiness of the selected applications to the user, and the selected subset of applications 206A, 206B, 206C, 206D, 206E, 206F can be displayed within the category 212. That is, the applications 206A, 206B, 206C, 206D, 206E, 206F shown in the New and Noteworthy category 212 of the user interface 200 can be a subset of a larger number of applications that also could qualify as being new and noteworthy but which have not been selected for display in the user interface 200.

In another example, the user interface 200 can include a category 214 of applications 208A, 208B, 208C, 208D, 208E that have been selected to be featured for display in the user interface 200. The applications 208A, 208B, 208C, 208D, 208E that are selected to be featured in the category 214 can be selected based on criteria evaluated by a curator of the market place. For example, the curator may select the applications 208A, 208B, 208C, 208D, 208E for display in the category 214 from a much larger set of applications based on the curator's opinion of the quality, popularity, or utility of the selected applications. In another implementation, the curator may select the applications 208A, 208B, 208C, 208D, 208E based upon payments made by developers of the applications in return for prominent display of the applications in the user interface 200.

The user interface 200 of the marketplace also can include categories of applications in other subportions of the user interface 200 in which smaller icons are used to represent the applications that are used in categories 212, 214, 216. For example, category 218 can display “Favorite Paid Apps,” which can be applications for which a user must pay money before being able to download and install the application on the user's computing device. Applications listed in the Favorite Paid Apps category 218 can be the most frequently downloaded and/or most frequently installed applications for which the user must pay money. In another example, category 220 can display “Staff Picks,” which can be applications that are selected by a curator at the marketplace based on the selected applications being deemed especially interesting to users who visit the marketplace in search of applications.

Other parts of the user interface 200 also can be used to organize the digital goods that are available in the marketplace. For example, an “Apps” section 222 can provide a list of hyperlinks, which each can be selected to display applications that belong to a category identified by the hyperlink. For example, selection of the “Education” hyperlink 223 can cause a group of icons that represent applications related to educational topics to be displayed. In another example, an “Extensions” section 224 can provide a list of hyperlinks, which each can be selected to display extensions that belong to a category identified by the hyperlink, where an extension is executable code that extends the functionality of a browser. For example, selection of the “Sports” hyperlink 225 can cause a group of icons that represent extensions related to sports topics to be displayed.

In addition to locating digital goods that are already displayed within a category 212, 214, 216, 218, 220 of the user interface 200, which could be displayed as a result of selecting a hyperlink 223, 225, digital goods also can be located as a result of a query for goods that may be of interest to the user. For example, a user may enter query terms into an query box 226 that may receive the query terms and pass the terms onto a search engine that then locates digital goods that match the query terms and that are available in the marketplace. For example, digital goods such as web applications can have a variety of metadata associated with them that are used to index the digital goods, and the query terms can be compared to the metadata associated with the digital goods. Based on the comparison, applications that best match the query terms can be selected from the digital goods available in the marketplace, and the selected goods can be presented to the user in the user interface 200.

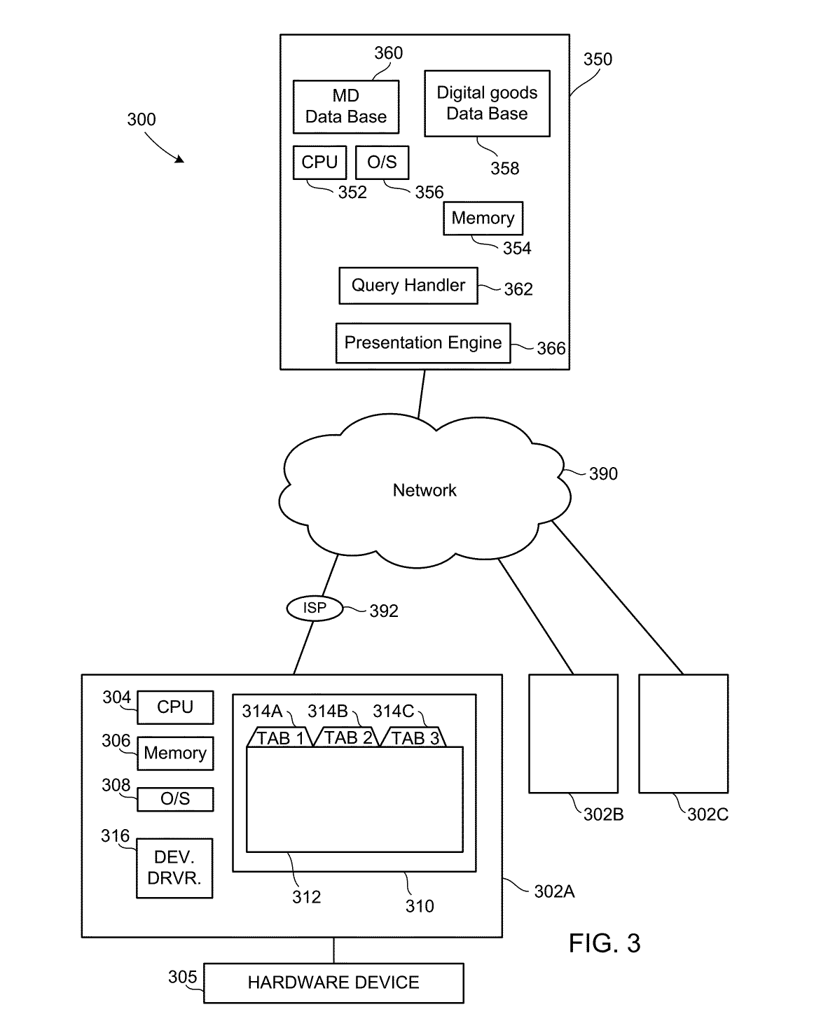

FIG. 3 is a schematic block diagram of an example embodiment of a system 300 used to search for and identify digital goods in a marketplace. In various embodiments, the system 300 may include client computing devices (e.g., desktop computers, notebook computers, netbook computers, tablet computers, smart-phone, etc.) 302A, 302B, 302C. A client computing device 302A can include one or more processors 304 and one or more memories 306. The client computing device 302A can execute an operating system 308 and an application 310 that may display a user interface window 312. The client computing device 302A can include a hardware device 305 that communicates with the operating system 308 via a device driver 316

In one embodiment, the client computing device 302A may be running or causing the operating system 308 to execute an application 310 or window 312. In some implementations, the window 312 can be a window of a web browser. In some implementations, the window 312 can be a window (e.g., a widget) that is executed independently of a browser. In various embodiments, this window 312 may include a plurality of panes or tabs 314A, 314B, 314C. The window 312 can be a visual area, usually rectangular, containing some kind of user interface. In a graphical user interface (GUI) used in the client device 302A, the window 312 can be a two-dimensional object arranged on a plane of the GUI known as the desktop. The window 312 can include other graphical objects, e.g., a menu-bar, toolbars, controls, icons and usually a working area in which the document, image, folder contents or other main object can be displayed.

The client computing devices 302A, 302B, 302C may receive online content from one or more server computing devices 350 that may be connected to the client device 302 through a network 390. Each of the client computing devices 302A, 302B, 302C can be connected to the network 390 through a local Internet Service Provider 392. The received online content can be processed and displayed in the window 312 (e.g., in a tab 314 of the window 312). For example, the window 312 can display a user interface to a marketplace for digital goods, similar to the user interface of the marketplace described herein, to a user.

The client computing device 302A can communicate with a digital goods marketplace server 350 that provides a marketplace for digital goods to client computing devices 302A, 302B, 302C. The marketplace server 350 can include one or more processors 352 and one or more memories 354. The marketplace server 350 can execute an operating system 356 and various applications and services to provide functionality to the client computing devices. For example, in one implementation, the marketplace server 350 can include a repository or database of digital goods 358, and the digital goods can be served from, or downloaded from, the repository to the client computing devices. In another implementation, the digital goods can be stored in, and served to client computing devices from, a repository that is remotely located from the marketplace server. For example, digital goods could be stored and served to client computing devices from individual repositories that are operated and controlled by developers of the digital goods, and digital goods repository 358 of the marketplace server 350 can provide just a reference to the individual repositories that are operated by the developers.

The marketplace server 350 can include a metadata database 360 that stores metadata associated with the digital goods that are available from or referenced by the digital goods repository 358. The metadata associated with a digital good can include a variety of information about the digital goods including, for example, information about the digital goods that are available from the repository 358. Such information can include, for example, representative keywords associated with the digital goods and the price associated with the digital goods. In the case of a device driver application for use with a specific hardware device 305, the metadata can include information that identifies the vendor and the product of the device 305. For example, the information could match the UUID or the vendorID and productID information that is provided by the device 305 to the operating system 308 when the hardware device 302 is coupled to the computing device.

The marketplace server 350 can include a query handler 362 that can be configured to receive and process queries for digital goods available in the marketplace. For example, the query handler can receive queries for digital goods that are entered into query box 226 of the user interface 200 shown in FIG. 2. Terms or phrases of the queries then can be compared to terms and phrases (e.g., terms and phrases stored in the metadata database 360) that are used to index the digital goods available in the marketplace. Based on the comparison, a subset of digital goods can be selected from the database 358 with which to respond to the query. In addition, the query handler can receive queries for digital goods that are initiated automatically in response to a hardware device 305 being coupled to the computing device 302A, where the automatically initiated query may include terms or phrases that identify the hardware device 305. The query then can be compared to terms and phrases (e.g., terms and phrases stored in the metadata database 360) that are used to index the device drivers available in the marketplace. Based on the comparison, a subset of device drivers that to respond to the query can be selected from the database 358.

The marketplace 350 can include a presentation engine 366 that prepares information for transmission to the client computing devices 302A, 302B, 302C, where the information is used by the client computing devices to display a user interface 200 that shows representations of selected digital goods available in the marketplace. For example, the presentation engine 366 can prepare HTML code, XML code, etc. that determines the information that is displayed to a user in the user interface 200 and where the code determines which digital goods will be displayed in the user interface 200 to the user.

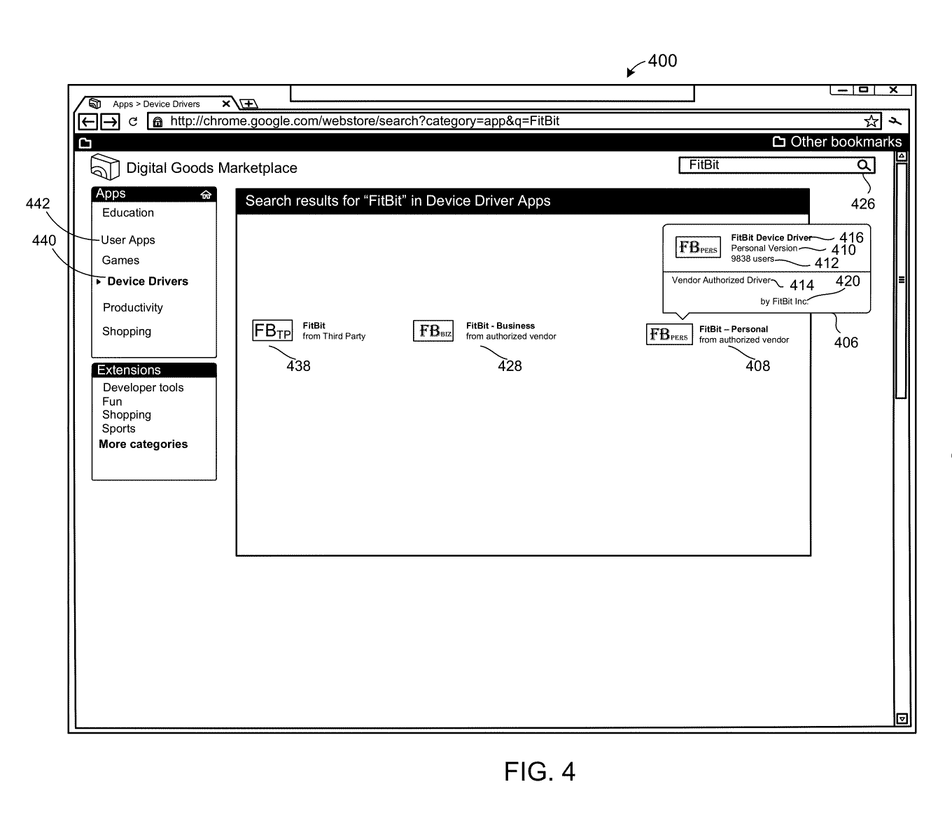

FIG. 4 is a screenshot of a user interface 400 to a marketplace of digital goods. The screenshot is representative of an implementation of a user interface that can be displayed when a FitBit™ hardware device 305 is coupled to a computing device 302A and a query for a device driver application for the FitBit™ device is automatically initiated and sent from the computing device 302A to the marketplace server 350. In some implementations, the term “FitBit” can be displayed in the query box 426 to indicate that a search has been performed for device driver applications for use with the Fitbit™ hardware device 305. The query term(s) displayed in the query box 426 and/or query terms that identify the hardware device 305 (e.g., the UUID or the vendor ID and the product ID associated with the device) can be compared to metadata associated with digital goods available within the marketplace, for example, metadata stored in metadata database 360. The metadata with which the query terms are compared can be derived from information in the manifest of the device driver (e.g., information that identifies the hardware device(s) that the device driver application is intended to be used with).

Based on the comparison, the query handler 362 can identify one or more device driver applications that are responsive to the query terms. A pop-up HTML window 406 can be displayed when a user moves a mouse icon over an icon for a device driver 408 that is displayed in the user interface 400. Within the pop-up HTML window 406, additional information about the device driver application 408 can be displayed. For example, a field 410 can indicate what type of version of the device driver the icon represents (e.g., a business/corporate version of a personal version). Another field 412 can indicate how many users have downloaded and/or installed and/or used the device driver. Another field 414 can display descriptive information about the device driver that supplements information in the title field 416. Another field 420 can display the name of the author or developer of the application.

As shown in FIG. 4, more than one device driver application or extension can be displayed in the user interface 400 as a result of a positive match between the automatically-initiated query in response to the coupling of the hardware device to the computing device. For example, in addition to an icon for the device driver application 408 that is provided by an authorized vendor (e.g., the manufacturer of the hardware device) and that is used for personal applications of the hardware device, an icon for a second device driver 428, and an icon for a third device driver 438 can be displayed in the user interface. The second device driver can represent, for example, a device driver that is provided by the authorized vendor and that is used for business or corporate applications of the hardware device, and the third device driver 438 can represent a device driver developed by a third party that is not affiliated with the authorized vendor. In some implementations, the marketplace may be configured to display, in response to the automatically-generated query that results from coupling of the hardware device to the computing device, only icons for device drivers that are developed, or explicitly approved, by an authorized vendor of the hardware device with which the device driver is to be used. In this manner, a user that couples the hardware device to a computing device may be presented with only device drivers developed were approved by original equipment manufacturers, while permitting third-party device drivers to be made available in the marketplace for users who search for them with a manually-generated query. The device driver applications may be displayed in a folder, tab, window, etc. that is identified by the “Device Drivers” heading 440, while other applications are displayed in other folders, tabs, windows, etc.

When a user selects one of the icons 408, 428, 438 of a device driver that is presented within the user interface 400, the device driver can be downloaded from the marketplace, installed on the user's computing device, and launched for use to provide dedicated communication services between the hardware device and the computing device.

In addition to automatically identifying kernel-level applications that provide dedicated communication services between hardware devices and operating systems of computing devices, the techniques described herein can be used to automatically identify user-level applications that are intended for use with particular hardware devices that are coupled to a computing device when the user-level applications are executed by the computing device. Such user-level applications may provide specialized applications that receive, process, manipulate, display, etc. information received from, or transmitted to, the hardware device. For example, user-level applications that are intended to be used with a GPS hardware device coupled to a computing device can include: a marine navigation application that receives positional information from the GPS device and displays the positional information in within an marine navigation chart, so that the user receives the benefit of viewing the accurate positional information from the GPS device in the context of a marine navigation chart; a route planning application that determines routes between a plurality of locations, which routes minimize time or distance traveled between the locations (the “traveling salesman problem”) and transmits the determined routes to the GPS system so that they can be communicated to a user; and a fitness tracking application that receives positional data from the GPS system about distances and times of a user's workouts (e.g., runs, bike rides, etc.) and analyzes the data to determine information, such as, for example, calories expended, improvements in fitness over time, etc.

Developers of user-level applications that are intended to be used in association with one or more particular hardware devices can identify the particular hardware device(s) in metadata associated with the applications. For example, the particular hardware devices can be identified by their UUID (for Bluetooth-connected devices) or by their vendor ID and product ID (for USB-connected devices). Then, in response to the coupling of a hardware device to a computing device, a search can be initiated automatically for user-level applications that identify the hardware device as one with which the applications are intended to be used. The automatic search can be executed over the curated data store 132 that hosts applications, including device-specific applications, which have been approved for installation and use on a computing device. The results of the search can be presented to a user of the computing device, and the user can elect to install one or more user-level applications for use with the hardware device on the computing device.

User-level applications identified in response to an automatically initiated search that is launched in response to the coupling of a hardware device to a computing device can be displayed along with, or instead of, device driver applications that provided dedicated communication services between the hardware device and the computing device. In one implementation, for example, within the user interface 400, user-level apps may be displayed with the “user apps” link 442 is selected, while device driver apps may be displayed when the “device driver apps” link is selected. A user may select a user-level application from the list of automatically displayed applications, and, in response, the application may be installed on the user's computing device.

To avoid overloading the user with too many suggested applications, user-level applications that are identified in response to the coupling of the hardware device to the computing device may not be displayed every time the hardware device is coupled to the computing device. For example, the suggested applications may be displayed only the first time the hardware device is coupled to the computing device, only when an indication is received that the computing device does not have installed a device driver application to provide dedicated communication services between the hardware device and the operating system of the computing device, etc.

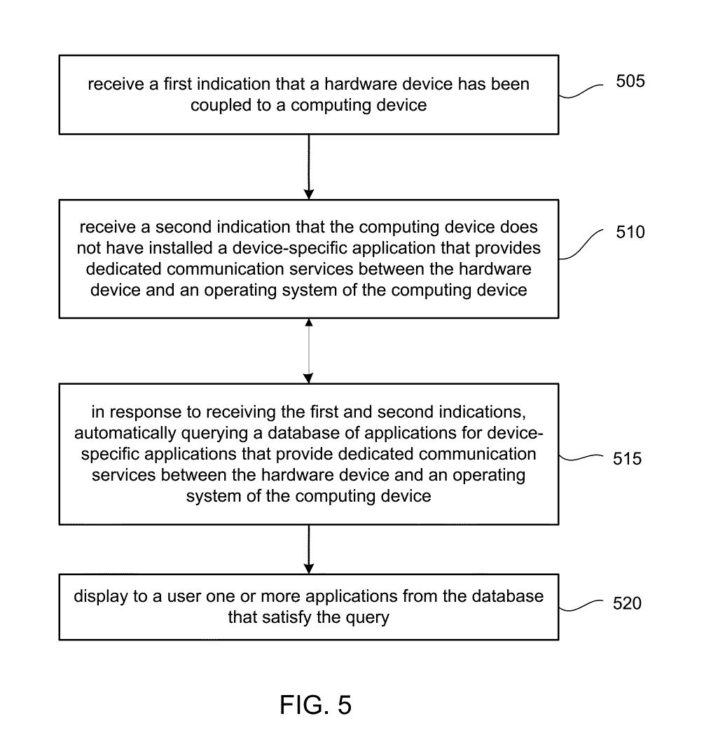

FIG. 5 is a flowchart of a process for automatically identifying device-specific applications that provide dedicated communication services between a hardware device and a computing device. The steps associated with FIG. 5 may be performed automatically by a user device. In other words, the steps of FIG. 5 may be performed as a background process without interaction with a user of the user device. As shown in FIG. 5, a first indication that a hardware device has been coupled to a computing device is received (505). For example, in one implementation, a hardware interrupt can be received from the hardware device by the computing device. A second indication that the computing device does not have installed a device-specific application that provides dedicated communication services between the hardware device and an operating system of the computing device is received (510). For example, an operating system of the computing device may attempt to locate such a device-specific application locally, on the device itself, and upon failure to locate one, an indication of such failure may be received by the operating system. In response to receiving the first and second indications, a database of applications is automatically queried for device-specific applications that provide dedicated communication services between the hardware device and an operating system of the computing device (515). For example, the computing device may automatically generate such a query and communicate the query to the database. Then, one or more applications from the database that satisfy the query are displayed to a user (520).

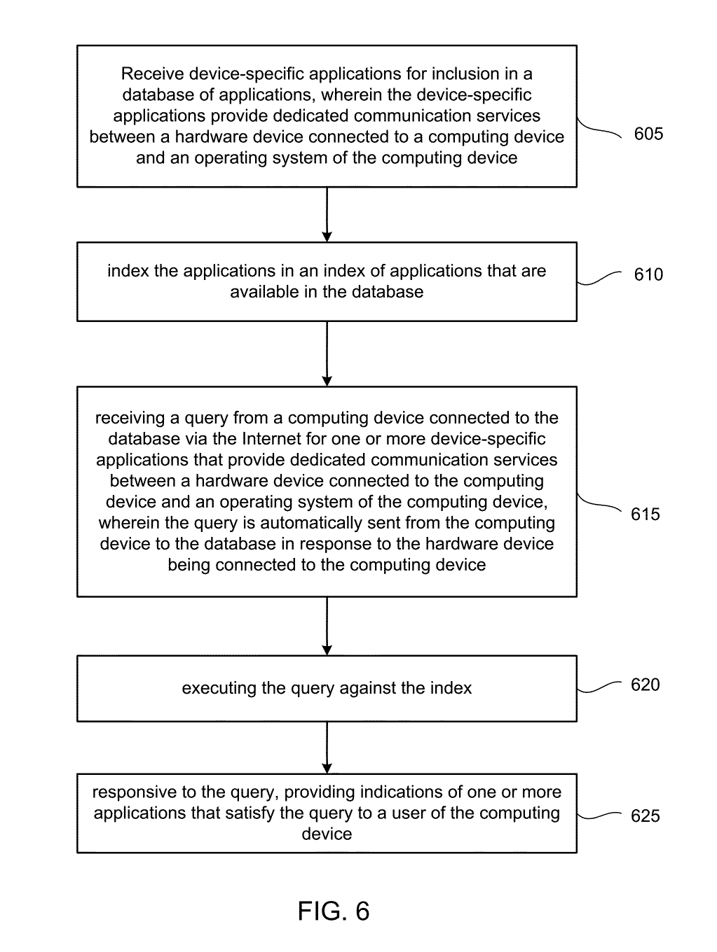

FIG. 6 is a flowchart of a process for automatically identifying device-specific applications that provide dedicated communication services between a hardware device and a computing device. As shown in FIG. 6, device-specific applications for inclusion in a database of applications are receive, where the device-specific applications provide dedicated communication services between a hardware device connected to a computing (605). The applications are indexed in an index of applications that are available in the database (610). After the index is in place, a query is received from a computing device connected to the database via the Internet for one or more device-specific applications that provide dedicated communication services between a hardware device connected to the computing device and an operating system of the computing device, where the query is automatically sent from the computing device to the database in response to the hardware device being connected to the computing device (615). The query is executed against the index (620). In response to the query, indications of one or more applications that satisfy the query are provided to a user of the computing device (625).

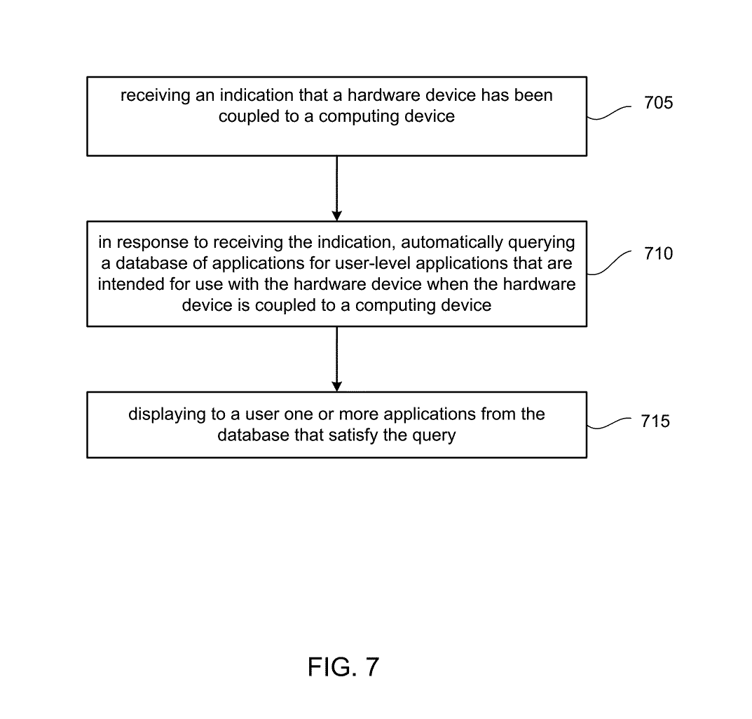

FIG. 7 is a flowchart of a process for automatically identifying user-level applications that are intended to be used with a particular hardware device when the hardware device is coupled to a computing device. As shown in FIG. 7, an indication that a hardware device has been coupled to a computing device is received (705). In response to receiving the indication, a database of applications is automatically queried for user-level applications that are intended for use with the hardware device when the hardware device is coupled to a computing device (710). One or more applications from the database that satisfy the query are displayed to a user (715).

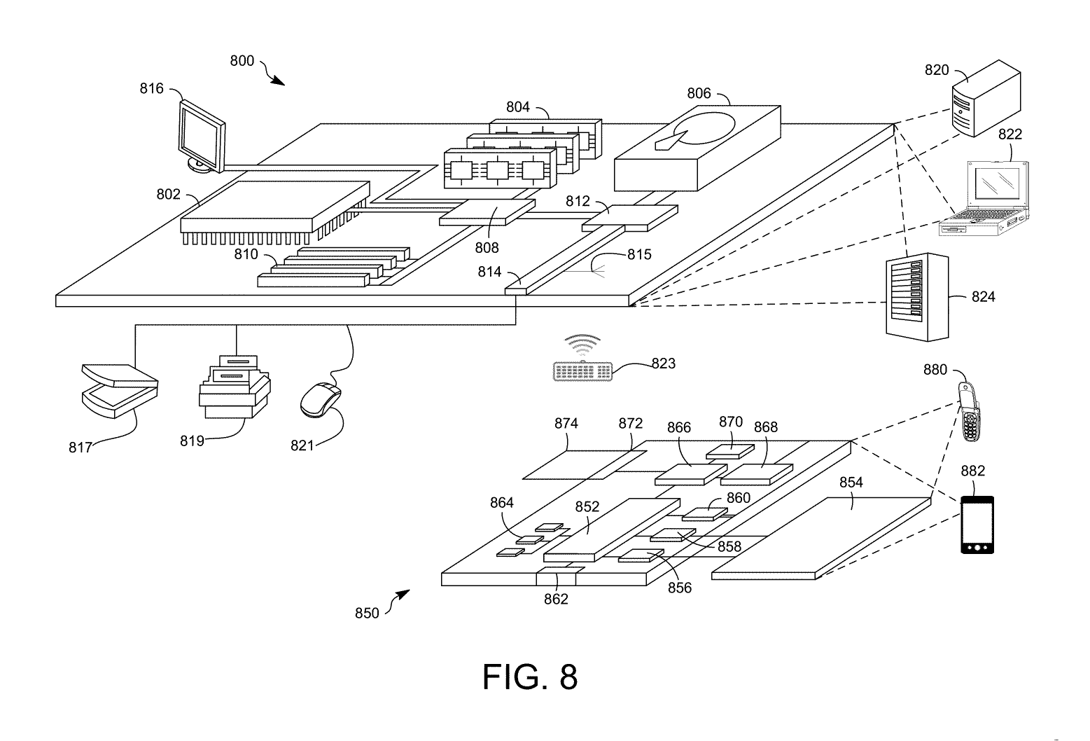

FIG. 8 shows an example of a generic computer device 800 and a generic mobile computer device 850, which may be used with the techniques described here. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smart phones, tablets, and other similar computing devices. The components shown here, their connections and relationships, and their functions, are meant to be exemplary only, and are not meant to limit implementations of the inventions described and/or claimed in this document. Each of computing device 800 and 850 can operate as computing device 104 that is coupled to a hardware device 102.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port 814, which may include various communication ports (e.g., USB) may be coupled to one or more devices, such as a keyboard 823, a pointing device 821, a scanner 817, or a printer. For example, the expansion port 814 can be coupled to external devices 817 819, 821 via a wired connection (e.g., a USB connection), and the expansion port can be coupled, via an antenna 815 to an external device 823 via a wireless connection (e.g., a Bluetooth connection). In addition to the devices 817, 819, 821, 823 depicted in FIG. 8, the computing device 800 can be coupled to other devices, by either or both wired or wireless connections, such as hardware devices that require a device-specific application to be installed on the computing device to provide dedicated communication services between the hardware device and an operating system of the computing device.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a BLUETOOTH, WiFi, or other such transceiver (not shown). In addition, GPS (Global Positioning System) receiver module 860 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made to the implementations described herein.

In addition, the logic flows depicted in the figures do not require the particular order shown, or sequential order. In addition, other steps may be provided, or steps may be eliminated, from the described flows, and other components may be added to, or removed from, the described systems. Accordingly, other implementations are within the scope of the following claims.

1. A computer-implemented method comprising:
receiving a first indication that a hardware device has been coupled to a computing device;
receiving a second indication that the computing device does not have installed a device-specific web browser application that provides dedicated communication services between the hardware device and an operating system of the computing device;
in response to receiving the first and second indications, automatically querying a database of web browser applications for device-specific web browser applications that can provide dedicated communication services between the hardware device and an operating system of the computing device; and
displaying to a user one or more web browser applications from the database that satisfy the query,
wherein a web browser application integrates with a web browser such that the web browser application is not executed natively on the client computing device and provides the dedicated communication services between the hardware device and the operating system of the computing device.

2. The computer-implemented method of claim 1, further comprising:
receiving a selection of one of the one or more displayed web browser applications; and
installing the selected one of the displayed applications.

3. The computer-implemented method of claim 2, wherein installing the selected one of the displayed web browser applications includes of adding the selected web browser application to the web browser or integrating the selected web browser application with the web browser.

4. The computer-implemented method of claim 1, wherein receiving the first indication that a hardware device has been coupled to a computing device includes receiving information about a vendor of the device, and wherein the query is based, at least in part, on the information about the vendor.

5. The computer-implemented method of claim 1, wherein receiving the first indication that a hardware device has been coupled to a computing device includes receiving a product ID of the device and wherein the query is based, at least in part, on the product ID.

6. The computer-implemented method of claim 1, wherein the device is coupled to the computing device via a USB link, wherein receiving the first indication that a hardware device has been coupled to a computing device includes receiving a device descriptor that identifies the device, and wherein the query is based, at least in part, on information about the device descriptor.

7. The computer-implemented method of claim 1, wherein the device is coupled to the computing device via a Bluetooth link, wherein receiving the first indication that a hardware device has been coupled to a computing device includes receiving a UUID that identifies the device, and wherein the query is based, at least in part, on the information about the UUID.

8. The computer-implemented method of claim 1, wherein the database maintains an index of metadata information about the web browser applications in the database, and wherein querying the database includes querying the index with one or more search terms descriptive of the device, which are matched against the index.

9. The computer-implemented method of claim 8, wherein terms of the index are based on terms found in manifests of web browser applications in the database.

10. A computer-implemented method comprising:
receiving device-specific web browser applications for inclusion in a database of web browser applications, wherein the device-specific web browser applications provide dedicated communication services between a hardware device connected to a computing device and an operating system of the computing device;
indexing the web browser applications in an index of web browser applications that are available in the database;
receiving a query from a computing device connected to the database via the Internet for one or more device-specific web browser applications that provide dedicated communication services between a hardware device connected to the computing device and an operating system of the computing device, wherein the query is automatically sent from the computing device to the database in response to the hardware device being connected to the computing device;
executing the query against the index; and
responsive to the query, providing indications of one or more web browser applications that satisfy the query to a user of the computing device,
wherein a web browser application integrates with a web browser such that the web browser application is not executed natively on the computing device and provides the dedicated communication services between the hardware device and the operating system of the computing device.

11. The computer-implemented method of claim 10, wherein
providing indications of the one or more web browser applications that satisfy the query includes proving indications only of web browser applications that satisfy the query and that have been validated as being associated with an approved developer for the hardware device.

12. The computer-implemented method of claim 10, wherein indexing the web browser applications includes indexing the web browser applications based on information contained in manifests of the web browser applications.

13. The computer-implemented method of claim 12, wherein the information in a manifest for a web browser application that provides dedicated communication services between a hardware device connected to a computing device via a Bluetooth link and an operating system of the computing device includes a UUID for the hardware device.

14. The computer-implemented method of claim 12, wherein the information in a manifest for a web browser application that provides dedicated communication services between a hardware device connected to a computing device via a USB link and an operating system of the computing device includes a device descriptor ID for the hardware device.

15. The computer-implemented method of claim 10, further comprising:
receiving a selection of one of the web browser applications that satisfies the query; and
in response to receiving the selection, installing the selected web browser application to the computing device.

16. The computer-implemented method of claim 10, wherein
the hardware device is coupled to the computing device via a USB link, and wherein the query is based, at least in part, on information about a device descriptor that identifies the hardware device.

17. The computer-implemented method of claim 10, wherein the hardware device is coupled to the computing device via a Bluetooth link, and wherein the query is based, at least in part, on information about a UUID that identifies the hardware device.

18. A computer-implemented method comprising:
receiving an indication that a hardware device has been coupled to a computing device;
in response to receiving the indication, automatically querying a database of web browser applications for user-level web browser applications that are intended for use with the hardware device when the hardware device is coupled to a computing device; and
displaying to a user one or more web browser applications from the database that satisfy the query,
wherein a web browser application integrates with a web browser such that the web browser application is not executed natively on the computing device and provides the dedicated communication services between the hardware device and the operating system of the computing device.

19. The computer-implemented method of claim 18, further comprising:
receiving a selection of one of the one or more displayed web browser applications; and
installing the selected one of the displayed web browser applications.

20. The computer-implemented method of claim 18, wherein the hardware device is coupled to the computing device via a USB link, wherein receiving the indication that a hardware device has been coupled to a computing device includes receiving a device descriptor that identifies the hardware device, and wherein the query is based, at least in part, on information about the device descriptor.

21. The computer-implemented method of claim 1, wherein a web browser application comprises at least one of a web browser extension, hypertext mark-up language content, cascading style sheets content, JavaScript content, and/or JavaScript Object Notation content.

22. The computer-implemented method of claim 1, wherein a web browser application accesses one or more application programming interfaces provided by a web browser.
